(19) United States
(12) Patent Application Publication
(10) Pub. No.: US 2005/0138781 A1
(43) Pub. Date: Jun. 30, 2005

(54) Structure bolt snap

(76) Inventor: Ching-Sung Chen, Chang Hua City (TW)

Correspondence Address: RABIN & BERDO, P.C., Suite 500, 1101 14th Street, N.W., Washington, DC, 20005, US

(21) Appl. No.: 10/745,618

(22) Filed: Dec. 29, 2003

(51) Int. Cl. F16B 45/04

(52) U.S. Cl. 24/600.8

(57) ABSTRACT

An improved structure bolt snap wherein a check member is situated in the movable bolt of the bolt snap retaining body to provide for the open and closed states of the retaining body via the actuating member horizontal smooth section located in the movable bolt passage, the external threads at the outermost extremity of which are fastened to the check member inside the movable bolt. When the retaining body is closed, the actuating member is rotated until the check member fastened to the actuating member is exposed at the outer periphery of the retaining body bore, disabling the downward movement of the actuating member such that the retaining body is maintained in a closed state, thereby effectively ensuring safe closure and coupling.

### BACKGROUND OF THE INVENTION

1) Field of the Invention

The invention herein relates to fasteners and connectors for coupling objects, specifically an improved structure bolt snap in which a check member is situated in the movable bolt of the bolt snap retaining body to provide for the open and closed states of the retaining body by means of a conjoined actuating member. When the retaining body is closed, the said actuating member is rotated until the check member fastened to the actuating member is exposed at the outer periphery of the retaining body bore, disabling the downward movement of the actuating member such that the retaining body is maintained in a closed state, thereby effectively ensuring safe closure and coupling.

2) Description of the Prior Art

There are now many type of snap bolts available for a wide range of applications such as those seen utilized for coupling objects onto handbag straps, key rings, hanging ornament belt clips, pet leashes, industrial-use clip straps, and other large and small items. Referring to FIG. 1-A and 1-B, in an observed retaining body structure, the said retaining body A is shaped like a question mark and contains a movable bolt C and a coil spring B and, furthermore, a long narrow slide slot C is cut along a bore A1 to provide for the insertion of an actuating member D into conjoinment with the movable bolt C; when the coil spring B inside the retaining body A bore A1 impels the movable bolt C upward, the uppermost extremity of the movable bolt C contacts the curved end area A3 of the retaining body A to thereby constitute the closed state; conversely, when the actuating member D is manually pressed down, the movable bolt C is shifted downward and compresses the coil spring B such that the upper most extremity of the movable bolt C no longer contacts the curved end area A3 of the retaining body 1 to thereby constitute the open state; although the said embodiment is convenient and innovative, when the retaining body A has an object and a cord (strap) E wrapped around or external force is inadvertently pulled downward on the actuating member D (as shown in FIG. 1-C), the actuating member D is easily nudged downward such that the retaining body A assumes the open state, thereby releasing the object F originally coupled in the retaining body A, a situation that should never occur.

Additionally, when the coupled object F is subjected to an external force, as indicated in FIG. 4, the path of force towards the movable bolt 3 causes the outward levering of the movable bolt 3 which not only results in the breakage of the movable bolt 3 but concentrates stress at the corners A21 defining the bottom section of the long narrow slide slot C in the retaining body A and, as such, fissures and damaging cracks develop at the said corners A21 during long-term usage.

In view of the said shortcomings, the applicant of researched and developed the invention herein, which is submitted in application for patent rights.

### SUMMARY OF THE INVENTION

The primary objective of the invention herein is to provide an improved structure bolt snap in which a movable bolt and a coil spring are contained in the bore within the retaining body of the bolt snap such that the bore has a long narrow slide slot to provide for the insertion of an actuating member into conjoinment with the movable bolt, an opening is formed in the movable bolt that is contiguous with a passage through which the actuating member is inserted, a check member is installed in the opening, and external threads are died on the outermost extremity of the actuating member horizontal smooth section; this then enables the coil spring inside the retaining body bore to impel the movable bolt upward such that the retaining body is closed and at the same time the said actuating member is rotated until the check member is exposed at the outer periphery of the retaining body bore, disabling the downward movement of the actuating member such that the retaining body is maintained in a closed state to thereby effectively ensure safe closure and coupling.

Another objective of the invention herein is to provide an improved structure bolt snap in which the lowest end of a long narrow slide slot formed along the bore in the retaining body is arcuately shaped, the arcuate shape capable of dispersing concentrated stress from pulling by an external force.

### BRIEF DESCRIPTION OF THE DRAWINGS

FIG. 1-A is an isometric drawing of the prior art.

FIG. 1-B is a cross-sectional drawing of the prior art.

FIG. 1-C is a cross-sectional drawing of the prior art when wrapped by a cord.

FIG. 1-D is an isometric drawing when the prior art is pulled by an external force.

FIG. 2 is an exploded drawing of the invention herein.

FIG. 3 is an isometric drawing of the invention herein following assembly.

FIG. 4 is a cross-sectional drawing of the invention herein when open.

FIG. 5-A is a cross-sectional drawing of the invention herein when closed.

FIG. 5-B is a cross-sectional drawing of the invention herein when closed.

FIG. 6-A is a cross-sectional drawing of the invention herein when closed and locked.

FIG. 6-B is a cross-sectional drawing of the invention herein.

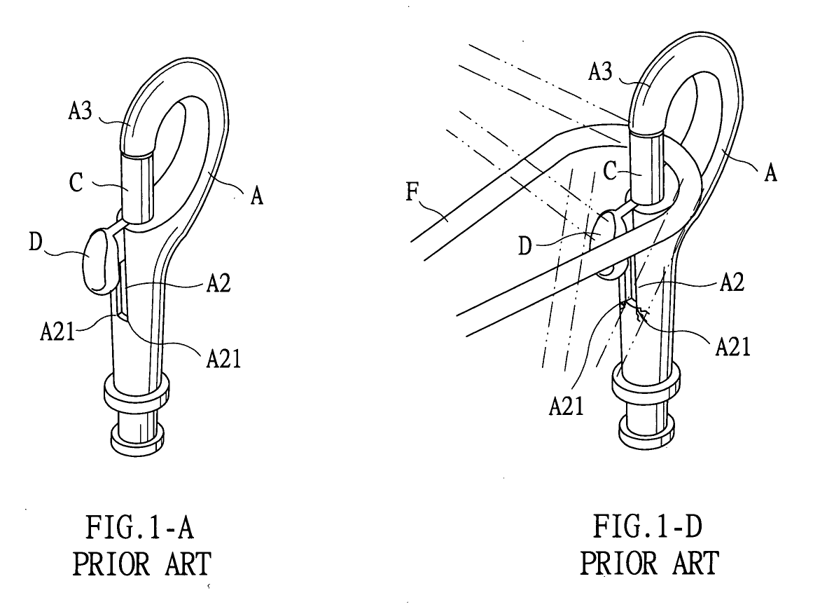

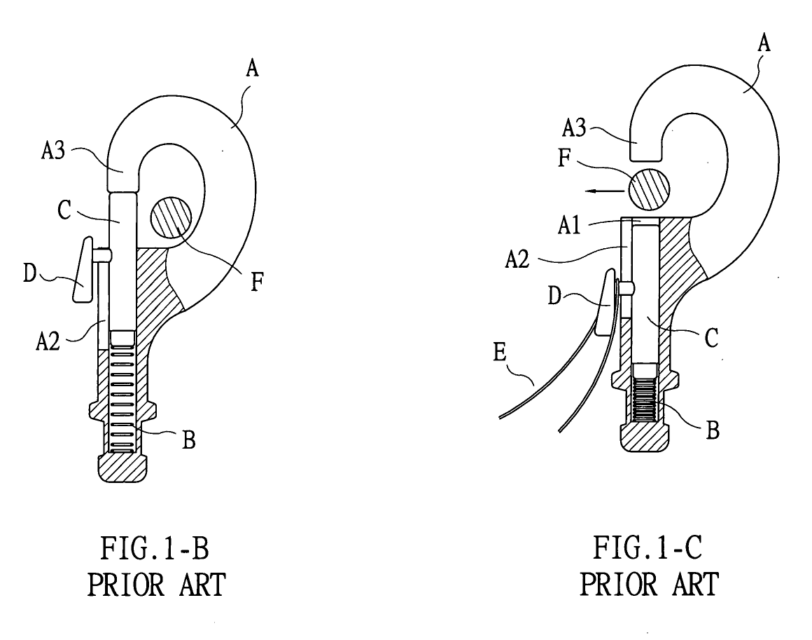

### DETAILED DESCRIPTION OF THE INVENTION

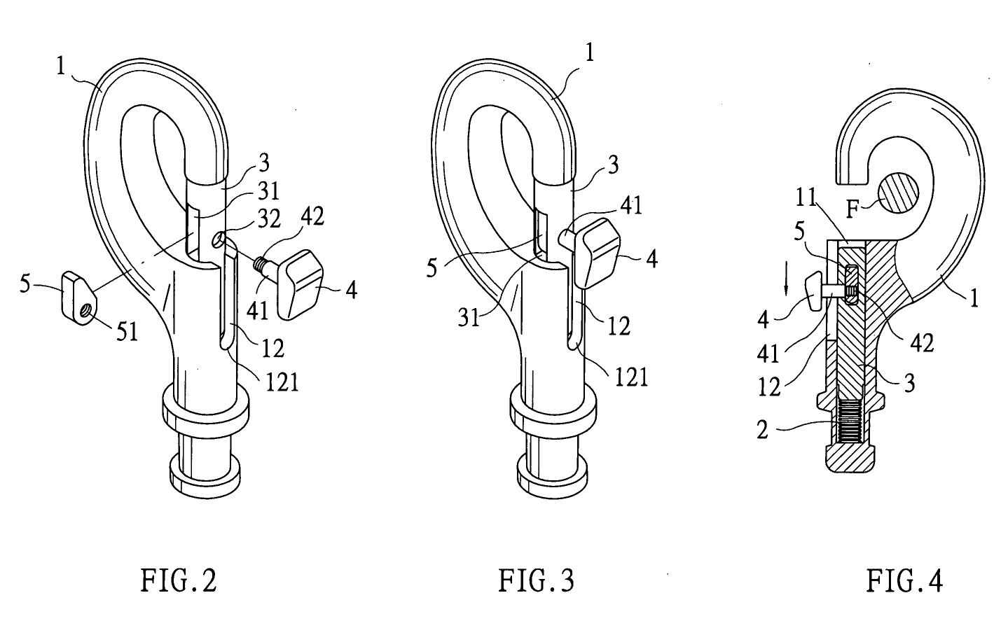

Referring to FIG. 2 and FIG. 3, the improved structure bolt snap of the invention herein consists of a retaining body 1 utilized for coupling objects onto handbag straps, key rings, hanging ornament belt clips, pet leashes, industrial-use clip straps, and other large and small items; the said retaining body 1 is shaped like a question mark, a movable bolt 3 and a coil spring 2 are disposed inside a bore 11 and, furthermore, a long narrow slide slot 12 is cut along the bore 11 to provide for the insertion of an actuating member 4 into conjoinment with the movable bolt 3, wherein the lowest end of the slide slot 12 is arcuately shaped 121, an opening 31 is formed in the movable bolt 3 that is contiguous with a passage 32 through which the actuating member 4 is inserted, a check member 5 is installed in the opening 31, and external threads 42 are died on the outermost extremity of the actuating member 4 horizontal smooth section 41; thus, when the actuating member 4 is assembled to the movable bolt 3, the horizontal smooth section 41 is located in the movable bolt 3 passage 32 and after the external threads 42 at the outermost extremity pass the movable bolt 3 passage 32, they are fastened to the internal threads 51 of the check member 5 inside the movable bolt 3.

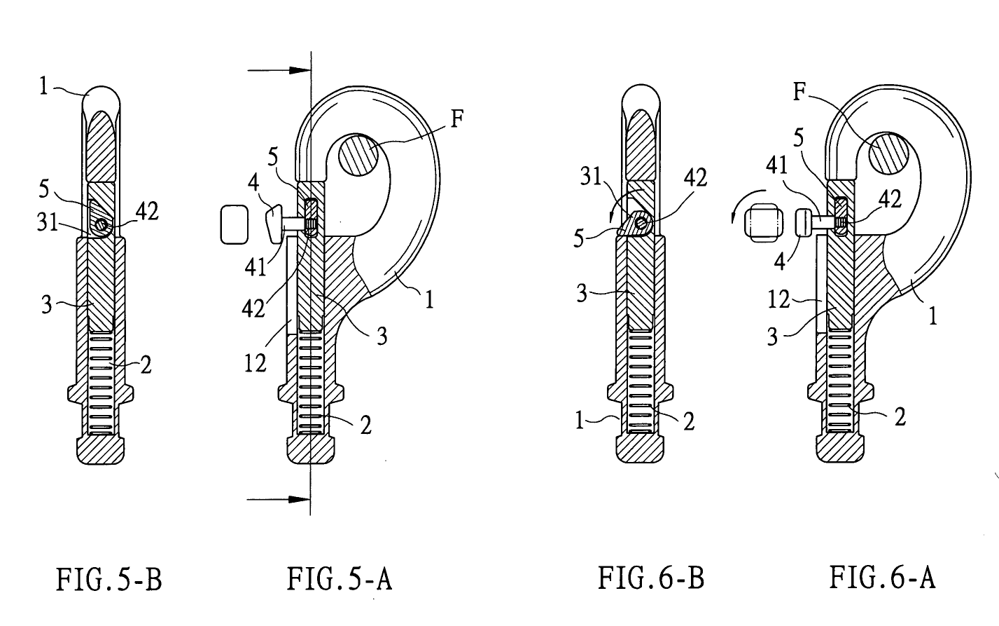

As such, when the retaining body 1 is open and the actuating member 4 is pressed down, the movable bolt 3 is shifted downward and compresses the coil spring 2 (as shown in FIG. 4) such that the uppermost extremity of the movable bolt 3 no longer contacts the curved end area of the retaining body 1 to thereby constitute the open state for accommodating the placement of an object F; when the actuating member 4 is thereafter released, the coil spring 2 inside the retaining body 1 bore 11 impels the movable bolt 3 upward such that the uppermost extremity of the movable bolt 3 once again contacts the curved end area of the retaining body 1 to thereby constitute the closed state (as shown in FIG. 5-A and FIG. 5-B) to couple the object F; at the same time, the said actuating member 4 is rotated until the check member 5 fastened to the actuating member 4 is exposed at the outer periphery of the retaining body 1 bore 11 (as shown in FIG. 6-A and FIG. 6-B), disabling the downward movement of the actuating member 4 such that the retaining body 1 is maintained in the closed state; as such, the said retaining body 1 prevents the actuating member 4 from accidental applications of external force and unintended operation, thereby effectively ensuring safe closure and coupling.

Additionally, when the coupled object F is pulled by an external force, since the path of force towards the movable bolt 3 results in the outward levering of the movable bolt 3 against the long narrow slide slot 12, the arcuately shaped 121 lowest end of the slide slot 12 disperses the concentrated stress from the path of force, thereby preventing fissures and the breakage of the slide slot 12 to protect the retaining body 1.

In summation of the foregoing section, since the invention herein provides for safe closure and coupling as well as the structural protection of the retaining body 1, the present invention meets new patent application requirements as stipulated in Article 97 and is submitted to the patent bureau for review and the granting of the commensurate patent rights.

1. An improved structure bolt snap in which a movable bolt and a coil spring are contained in the bore within the retaining body of the bolt snap to provide for the insertion and fastening of an actuating member to the said movable bolt, wherein an opening is formed in the said movable bolt that is contiguous with a passage through which the said actuating member is inserted and, furthermore, a check member is installed in the said opening, internal threads are tapped in the said check member, and external threads are died on the outermost extremity of the said actuating member horizontal smooth section; the said horizontal smooth section is located in the said movable bolt passage and after the said external threads at the outermost extremity pass the said movable bolt passage, they are fastened to the internal threads of the said check member inside the said movable bolt; when the said coil spring inside the said retaining body bore impels the said movable bolt upward, the said retaining body is closed and after the said actuating member is rotated until the said check member fastened to the said actuating member is exposed at the outer periphery of the said retaining body bore, disabling the downward movement of the said actuating member such that the said retaining body is maintained in a closed state, thereby effectively ensuring safe closure and coupling.

2. An improved structure bolt snap in which the lowest end of a long narrow slide slot formed along the said bore in the said retaining body is arcuately shaped, the said arcuate shape capable of dispersing concentrated stress from pulling by an external force.
